(19) United States
(12) Patent Application Publication
(10) Pub. No.: US 2025/0094022 A1
(43) Pub. Date: Mar. 20, 2025

(54) DETERMINING ELIGIBILITY OF CONTENT LOCATORS FROM PREVIOUS COMPUTING DEVICE

(71) Applicant: Google LLC, Mountain View, CA (US)

(72) Inventors: Daniel Peng, Seattle, WA (US); Jorge Zuniga, Falls Church, VA (US); Nesrine Changuel, Vanves (FR); Sophie Chang, Seattle, WA (US); Thomas Nont Boonsiri, Santa Clara, CA (US); Tarun Bansal, Bellevue, WA (US); Matthew Spencer Rendely, Seattle, WA (US); Nasim Sedaghat, Montreal (CA)

(21) Appl. No.: 18/488,555

(22) Filed: Oct. 17, 2023

(30) Foreign Application Priority Data
Sep. 18, 2023 (EP) 23315359

(51) Int. Cl. G06F 3/0483

(52) U.S. Cl. CPC G06F 3/0483

(57) ABSTRACT

A non-transitory computer-readable storage medium can include instructions stored thereon that, when executed by at least one processor, are configured to cause a computing device to receive a first content locator and a second content locator, content associated with the first content locator being previously accessed by a previous computing device in association with a user account and content associated with the second content locator being previously accessed by the previous computing device in association with the user account; determine that the content associated with the first content locator is eligible for viewing on the current computing device; determine that the content associated with the second content locator is ineligible for viewing on the computing device; and present, using a web browser associated with the user account, content associated with the first content locator without presenting content associated with the second content locator.

### CROSS-REFERENCE TO RELATED APPLICATIONS

This application claims priority to European Patent Application No. 23315359.2, filed on Sep. 18, 2023, entitled “DETERMINING ELIGIBILITY OF CONTENT LOCATORS FROM PREVIOUS COMPUTING DEVICE”, the disclosure of which is incorporated by reference herein in its entirety.

### TECHNICAL FIELD

This description relates to web browsing.

### BACKGROUND

Users browse websites on computing devices. Users may use various different computing devices in conjunction with a user account to browse websites.

### SUMMARY

A current computing device can determine eligibility of content associated with content locators for viewing on the current computing device. The current computing device can present the content locators for which the content is determined to be eligible, and not present the content locators for which the content is determined to be ineligible.

According to an example, a non-transitory computer-readable storage medium comprises instructions stored thereon. When executed by at least one processor, the instructions are configured to cause a current computing device to receive a first content locator and a second content locator, content associated with the first content locator being previously accessed by a previous computing device in association with a user account and content associated with the second content locator being previously accessed by the previous computing device in association with the user account; determine that the content associated with the first content locator is eligible for viewing on the current computing device; determine that the content associated with the second content locator is ineligible for viewing on the current computing device; and present, using a web browser associated with the user account, content associated with the first content locator without presenting content associated with the second content locator based on the determination that the content associated with the first content locator is eligible for viewing on the current computing device and the determination that the content associated with the second content locator is ineligible for viewing on the current computing device.

According to an example, a computing device includes at least one processor and a non-transitory computer-readable storage medium. The non-transitory computer-readable storage medium comprises instructions stored thereon that, when executed by the at least one processor, are configured to cause the computing device to receive a first content locator and a second content locator, content associated with the first content locator being previously accessed by a previous computing device in association with a user account and content associated with the second content locator being previously accessed by the previous computing device in association with the user account; determine that the content associated with the first content locator is eligible for viewing; determine that the content associated with the second content locator is ineligible for viewing; and present, using a web browser associated with the user account, content associated with the first content locator without presenting content associated with the second content locator based on the determination that the content associated with the first content locator is eligible for viewing and the determination that the content associated with the second content locator is ineligible for viewing.

According to an example, a method performed by a computing device comprises receiving a first content locator and a second content locator, content associated with the first content locator being previously accessed by a previous computing device in association with a user account and content associated with the second content locator being previously accessed by the previous computing device in association with the user account; determining that the content associated with the first content locator is eligible for viewing; determining that the content associated with the second content locator is ineligible for viewing; and presenting, using a web browser associated with the user account, content associated with the first content locator without presenting content associated with the second content locator based on the determination that the content associated with the first content locator is eligible for viewing and the determination that the content associated with the second content locator is ineligible for viewing.

The details of one or more implementations are set forth in the accompanying drawings and the description below. Other features will be apparent from the description and drawings, and from the claims.

### BRIEF DESCRIPTION OF THE DRAWINGS

FIG. 1A shows a user accessing content on a first computing device.

FIG. 1B shows the user accessing content on a second computing device.

FIG. 1C shows networks via which the user accesses the content.

FIG. 2A shows a web browser with multiple tabs.

FIG. 2B shows a web browser with one of the tabs from FIG. 2A filtered out.

FIG. 2C shows a web browser with tabs associated with suggested content.

FIG. 3 is a timing diagram showing actions performed by, and messages sent between, computing devices and servers.

FIG. 4A shows a web browser presenting content in which a portion of the content has already been viewed.

FIG. 4B shows another web browser presenting the content presented by the web browser of FIG. 4A.

FIG. 5 shows a web browser with user interface elements that facilitate viewing desired content.

FIG. 6A is a block diagram of a computing device.

FIG. 6B is a block diagram of a server.

FIG. 7 is a flowchart of a method performed by a computing device.

Like reference numbers refer to like elements.

### DETAILED DESCRIPTION

A user who browsed websites on a previous computing device can launch a web browser on a current computing device. The web browser can be launched in association with a user account associated with the user, or the user can log into the user account while the web browser is executing on the current computing device. Implementations provide a consistent experience across devices and minimizes user interactions with a client device by proactively surfacing content on the current device that the user accessed on a prior device. The proactive surfacing may include intelligence, e.g., proactively surfacing content that has the highest probability of being accessed by the user on the current computing device. To enable the proactive surfacing, the current computing device can receive content locators. The content locators can be associated with websites and/or content previously accessed within the previous computing device.

The current computing device can determine eligibility of the content for viewing on the current computing device. The determination of eligibility can be based, for example, on text included in the content, classifications of the content locators, a network via which the current computing device received the content locators, and/or interactions between the user and the content. The current computing device can determine which content the user is most likely to select and/or view. The current computing device can present content locators for which the content is determined to be eligible (and the user is likely to view), without presenting content locators for which the content is determined to be ineligible. The current computing device can also rank eligible received content locators to determine which content to suggest or to automatically resume on the current computing device. The ranking can be based on a likelihood (probability) that the user will request to view the content associated with the respective content locator. Thus, the receipt of content locators support a user's search for content and assist the user in searching for the content by a continued and/or guided human-machine interaction process.

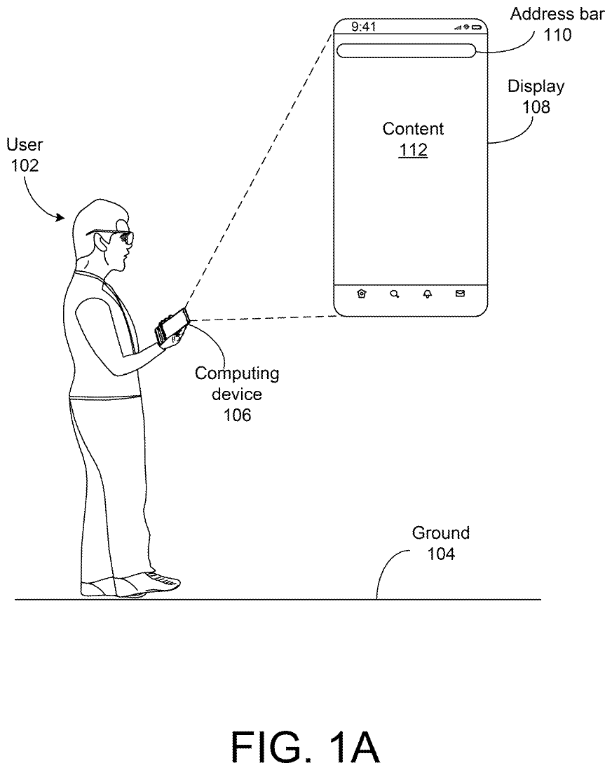

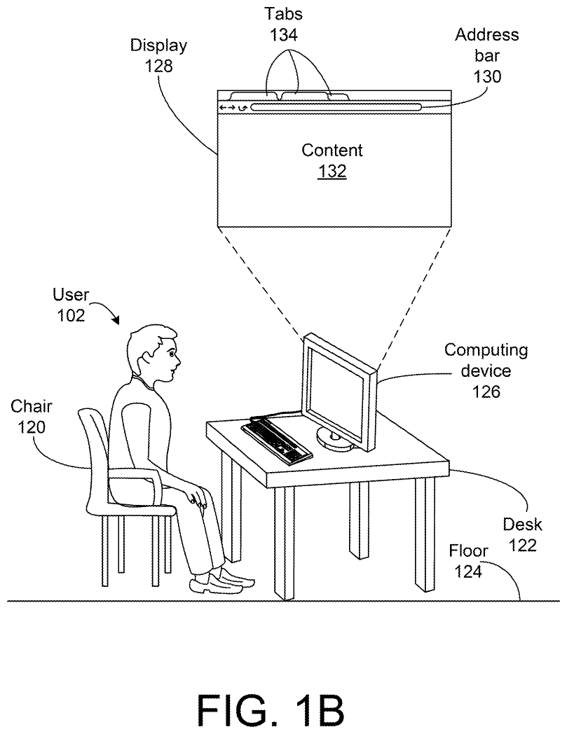

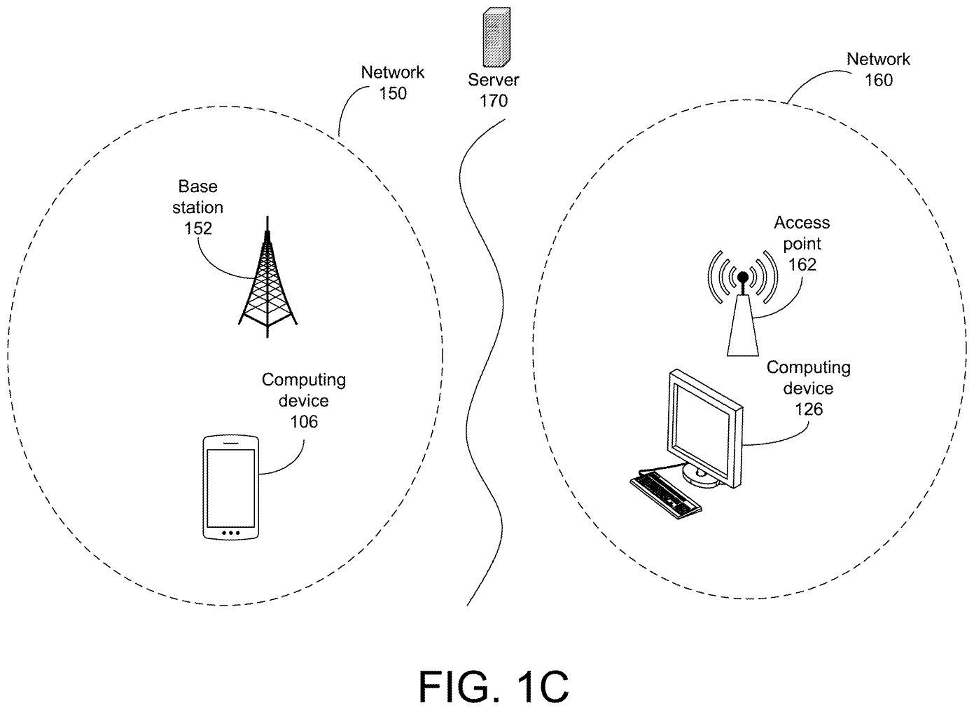

FIG. 1A shows a user 102 accessing content 112 on a first computing device 106. In the example shown in FIG. 1A, the user 102 is walking along the ground 104 and holding the first computing device 106. The first computing device 106 can be considered a previous computing device (with reference to a second computing device 126 and/or current computing device shown and described with respect to FIG. 1B). The user 102 can view content 112 displayed by a web browser executing on the first computing device 106.

A display 108 of the first computing device 106 is shown in greater detail. The computing device 106 is executing a web browser. The web browser can execute on the computing device 106 in association with a user account, such as a user account associated with the user 102. The user 102 may have logged into the user account via the web browser.

The computing device 106 presents the web browser via the display 108. The display 108 presents, and/or the web browser includes, an address bar 110. The address bar 110 includes and/or displays a content locator. An example of a content locator included in and/or displayed by the address bar 110 is a uniform resource locator (URL). The content locator can be associated with content, such as the content 112 displayed by the computing device 106 within the web browser. The content locator can identify and/or address a server that sends the content 112, and/or code such as HyperText Markup Language (HTML) code for generating the content 112, to the computing device 106.

After viewing the content 112 on the display 108 of the first computing device 106, the user 102 may stop using the first computing device 106 and start using a different computing device. The user 102 may stop using the first computing device 106 because the different (second) computing device has a larger display, or because a battery included in the first computing device 106 has lost power, as non-limiting examples. The user 102 may desire to access the same content 112 on the new computing device.

FIG. 1B shows the user 102 accessing content on a second computing device 126. The second computing device 126 can be considered a current computing device. The user 102 may have stopped using the first computing device 106 and begun using the second computing device 126. In the example shown in FIG. 1B, the second computing device 126 is a desktop computer. The second computing device 126 rests on a desk 122. The user 102 is sitting on a chair 120 at the desk 122. The chair 120 and desk 122 are supported by a floor 124.

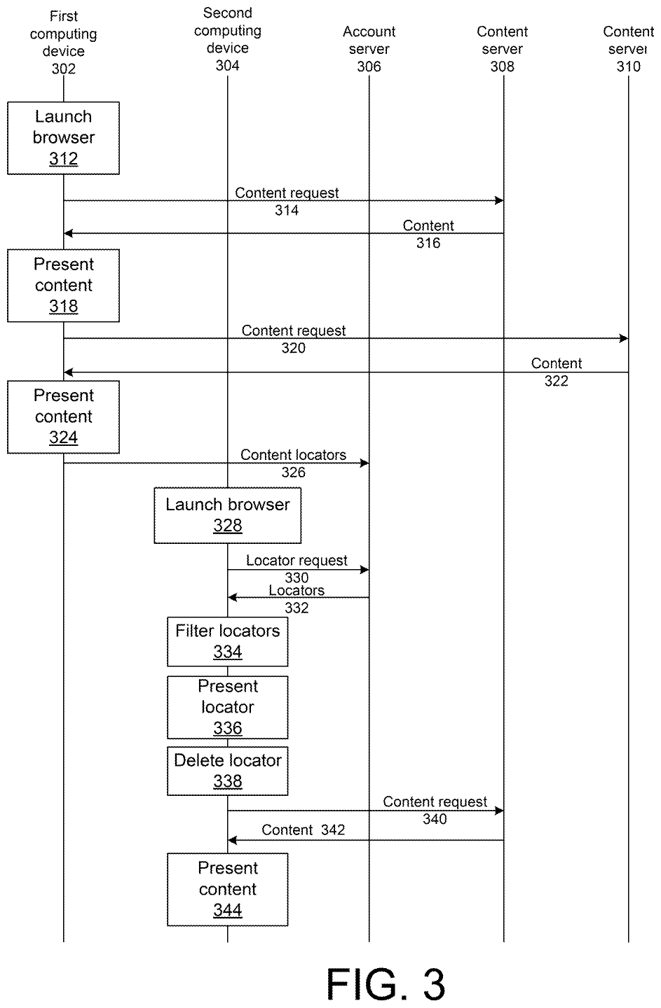

While interacting with the second computing device 126, the user 102 can launch, and/or prompt the second computing device 126 to launch, a web browser. In some examples, the second computing device 126 launches the web browser in association with a user account that is associated with the user 102. In some examples, the user 102 logs into the user account via the web browser while the web browser is executing on the second computing device 126. In some examples, the web browser executes in association with the user account, such as while the user account is logged into the web browser and/or second computing device 126. For example, the user may have enabled content synchronization, indicating a desire for content to be synchronized across devices when the user is logged into the user account associated with the user. The content synchronization can occur periodically, such as every predetermined time period, or in response to content requests (such as the content requests 320, 330, 340 shown and described with respect to FIG. 3).

To facilitate the user 102 continuing to access content that was previously accessed on the first computing device 106, the second computing device 126 can present content and/or tabs associated with the content to the user 102. The second computing device 126 can receive content locators associated with the content from a server associated with the user account, such as a server that the user 102 logged into in association with the user account. The second computing device 126 can determine eligibility, for viewing on the second computing device 126, of the content associated with the received content locators. In some examples, the second computing device 126 may rank the content locators in order of likelihood (probability) that the user will request to view the content associated with the respective content locator. The second computing device 126. For content that the second computing device 126 determines is eligible, the second computing device 126 can present the content and/or associated content locator without presenting content that the second computing device determines is ineligible. In some examples, the second computing device 126 may use the ranked content locators to select a portion of the content locators for suggestion to the user. For example, the second computing device 126 may present the content and/or associated content locator of the n most likely content locators, where n is a predetermined number. In some implementations, n may be one, two, or three. In some implementations, n may be any content where the probability is above a threshold. In some implementations, n may be based on a number of content locators that can be presented on a display of the second computing device 126. The number of content locators that can be presented on a display of the second computing device 126 can, for example, be limited by the amount of memory available in the second computing device 126. For content that the second computing device 126 determines is ineligible, the second computing device 126 does not present the content and/or associated content locator. In some implementations, for content that or is not within the n most likely content locators, the second computing device 126 does not present the content and/or associated content locator.

FIG. 1B shows a display 128 included in the second computing device 126 in greater detail. The display 128 presents the web browser executing on the second computing device 126. The display 128 presents an address bar 130 included in the web browser. The address bar 130 can include and/or present a content locator such as a URL. The display 128 can present content 132 associated with the content locator included in the address bar 130. The display 128 presents tabs 134 included in the web browser. The tabs 134 are each associated with a content locator. The user 102 can select a tab, such as by clicking on the tab. Selection of the tab will cause the web browser presented on the display 128 to present a content locator associated with the tab in the address bar 130 and will cause the web browser presented on the display 128 to present the content associated with the tab and/or content locator.

FIG. 1C shows networks 150, 160 via which the user 102 accesses the content 112, 132. FIG. 1C illustrates an example where a determination of whether content is eligible can be based in part on the network via which the user is accessing content. The user 102 can access the content 112, 132 via different networks 150, 160. For example, the user 102 can access the content 112 with the first computing device 106 via a first network 150, and access the content 132 with the second computing device 126 via a second network 160. In some examples, the user 102 can access content 112 with the first computing device 106 via the first network 150, walk into the second network 160 with the first computing device 106 and the first computing device 106 will hand off from the first network 150 to the second network 160 so that the user 102 can access the content 112 with the first computing device 106 via the second network 160. The user 102 can then stop using the first computing device 106 and start using the second computing device 126 and access the content 132 with the second computing device 126 via a second network 160.

In the example shown in FIG. 1C, the first network 150 is a cellular network, such as a long-term evolution (LTE) or new radio (NR) network, and the first computing device 106 receives the content 112 from a remote content server or web server via a base station 152 and a backhaul network. In the example shown in FIG. 1C, the second network 160 can be a wireless local area network (WLAN), such as an Institute for Electrical and Electronics Engineers (IEEE) 802.11 (Wireless Fidelity) network or a local area network (LAN) such as an IEEE 802.3 Ethernet network, and the second computing device 126 receives the content 112 from a remote content server or web server via an access point 162. The access point 162 can be an IEEE 802.11 wireless router or an IEEE 802.3 Ethernet router. These are merely examples. The computing devices 106, 126 can receive the content 112, 132 from the respective servers via networks of various technologies. The user 102 can access content on the first computing device 106 via the first network 150 and, when entering the second network 160, the first computing device 106 can determine whether the content is eligible for viewing and/or accessing via the second network 160. The first network may be, for example, a home or public network and the second network 160 may, for example, be a work network in which viewing certain content may be inappropriate.

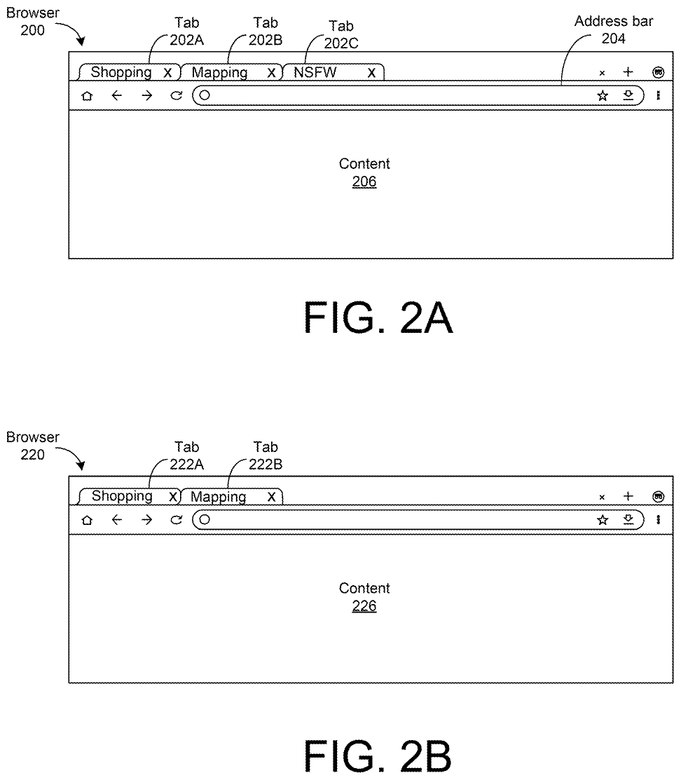

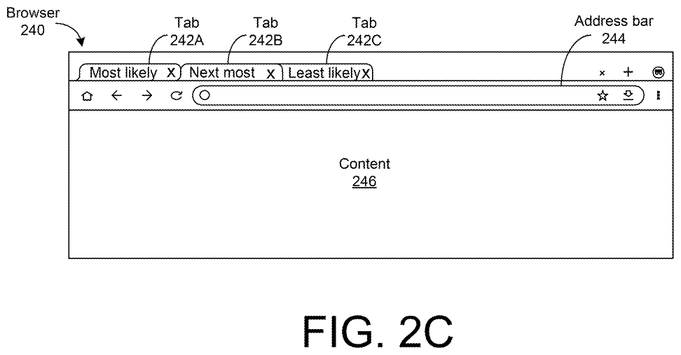

As discussed previously, a user can access content via a web browser on a first computing device, and when the user launches a web browser on a second computing device, the second computing device can determine whether the content is eligible for viewing on the second computing device. In some examples, the second computing device can also rank the content locators that are associated with eligible content. FIG. 2A shows a web browser executing on a first computing device (such as a previous computing device) via which a user has accessed different instances of content that are associated with different content locators, and FIG. 2B shows a web browser executing on a second computing device (such as a current computing device) that has determined that some of the content accessed on the first computing device is not eligible for viewing on the second computing device.

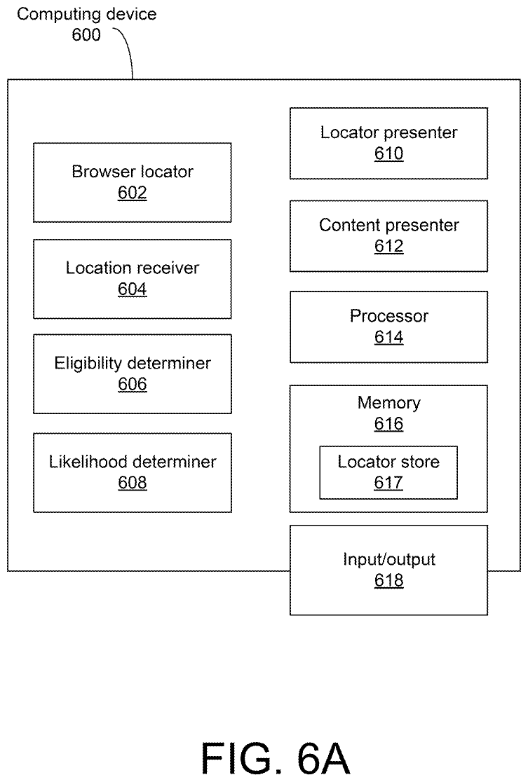

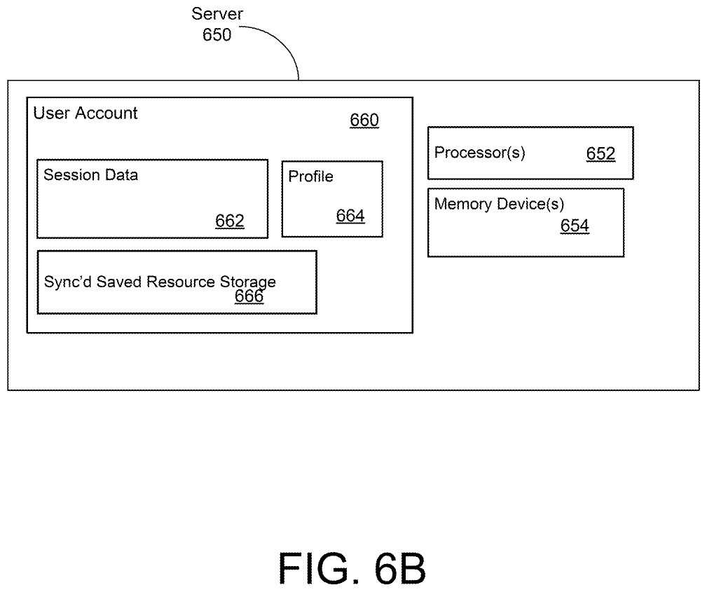

The computing devices 106, 126 can communicate with a server 170. The computing devices 106, 126 can communicate with the server 170 via the base station 152 and/or access point 162. The base station 152 and/or access point 162 can communicate with the server 170 via a network such as the Internet. The server 170 can store and provide content to the computing devices 106, 126. The server 170 can perform any combination of functions described with respect to servers 306, 308, 310 shown and described with respect to FIG. 3 and/or the server 650 shown and described with respect to FIG. 6B.

FIG. 2A shows a web browser 200 with multiple tabs. The web browser 200 can be executing on a first computing device, which can be considered a previous computing device. The web browser 200 can be a multi-tabbed web browser with multiple tabs 202A, 202B, 202C. Each tab 202A, 202B, 202C can be associated with a different content locator and/or content. In some examples, the association with the content locator and/or content includes indicating and/or presenting a word or words that suggests the content locator and/or content. In some examples, the association with the content locator and/or content includes presenting a title and/or an icon (favicon) of a webpage associated with the content locator and/or content. In the example shown in FIG. 2A, the web browser 200 includes a first tab 202A associated with shopping content, a second tab 202B that is associated with mapping content, and a third tab 202C associated with content that is not suitable for work (NSFW). In some examples, the current computing device classifies the content associated with each tab into verticals. A vertical represents the classification type of locator associated with a website or the content associated with a webpage served by the website. For example, a vertical can be a shopping vertical or a travel vertical or a news vertical or an adult content vertical. For example, the current computing device may have classified the content associated with the first tab 202A as a shopping vertical, classified the content associated with the second tab 202B as a mapping vertical, and classified the content associated with the third tab 202C as a not suitable for work vertical. Content that is not suitable for work can include, for example, any content that aligns with personal leisure time, such as a game or social networking site. The web browser 200 includes an address bar 204 that receives and/or presents a content locator associated with an in-focus tab (which may be any of the tabs 202A, 202B, 202C). The web browser 200 includes a display area that presents content 206 associated with the content locator that is associated with the in-focus tab. The web browser 200 may have additional tabs open beyond the three tabs 202A, 202B, 202C shown in FIG. 2A.

FIG. 2B shows a web browser 220 with one of the tabs from FIG. 2A filtered out. Although not illustrated, the web browser 220 may present additional open tabs beyond the tabs 222A, 222B. In this example, the user has launched the web browser 220 on a second computing device, which can be considered a current computing device. The second computing device and/or web browser 220 has received the content locators associated with the tabs 202A, 202B, 202C that were open on the first computing device, which can be considered a previous computing device. The second computing device and/or web browser 220 determined that the content associated with the tab 202C was ineligible for viewing on the second computing device. The second computing device and/or web browser 220 determined that content associated with the tabs 202A and/or 202B was eligible for viewing on the second computing device. Based on the determination that the content associated with the tab 202C was ineligible for viewing on the second computing device, the second computing device and/or web browser 220 does not present the content associated with the tab 202C, such as by filtering out and/or deleting the content identifier associated with the tab 202C. Put another way, the second computing device and/or web browser 220 does not present a tab associated with the content locator associated with the tab 202C. The second computing device and/or web browser 220 presents the content associated with the tabs 202A, 202B without presenting content associated with the tab 202C based on determining that content associated with the tabs 202A and/or 202B is eligible for viewing on the second computing device and content associated with the tab 202C is ineligible for viewing on the second computing device. In the example of FIG. 2B, based on determining that content associated with the content locator associated with the tab 202A and tab 202B is eligible for viewing on the second computing device, the second computing device and/or web browser 220 presents tabs 222A and, 222B, which display the content associated with the tab 202A and tab 202B, respectively. The second computing device and/or web browser 220 also presents content 226 that was determined to be eligible for viewing on the second computing device. The second computing device and/or web browser 220 can present content 226 that is associated with the active (in focus) tab, e.g., 222B. In some examples, the tab 222A is associated with a same content locator as the tab 202A. In some examples, the tab 222B is associated with a same content locator as the tab 202B.

In some examples, when the user launches a web browser and/or logs into a user account via the web browser, the web browser presents suggested websites and/or content locators. The web browser can present the suggested websites and/or content locators in order of likelihood that the user will access content associated with the websites and/or content locators.

FIG. 2C shows a web browser 240 with tabs 242A, 242B, 242C associated with suggested content. The suggested content is based on ranking of the content performed by the computing device on which the web browser 240 is executing. The ranking can be based, for example, on content and/or a web page that the user most recently visited and/or interacted with, that the user most frequently visits and/or interacts with, and/or associations between the time of day and content that the user visits and/or interacts with during similar times of the day, as non-limiting examples. In the example shown in FIG. 2C, the left-most tab 242A is associated with the content that the web browser 240 has determined that the user is most likely to select (the text included in the tab 242A can indicate the content associated with the tab 242A rather than the likelihood of the user selecting the tab 242A). In the example shown in FIG. 2C, the middle tab 242B is associated with the content that the web browser 240 has determined that the user is next-most likely to select (the text included in the tab 242B can indicate the content associated with the tab 242B rather than the likelihood of the user selecting the tab 242B). In the example shown in FIG. 2C, the right-most tab 242C is associated with the content that the web browser 240 has determined that the user is next-most likely to select after the middle tab 242B (the text included in the tab 242C can indicate the content associated with the tab 242C rather than the likelihood of the user selecting the tab 242C). The web browser 240 can include an address bar 244 that presents a content locator associated with the tab 242A, 242B, 242C that has been selected. The web browser 240 can present content 246 associated with the tab 242A, 242B, 242C that has been selected.

FIG. 3 is a timing diagram showing actions performed by, and messages sent between, computing devices and servers. A first computing device 302 can be considered a previous computing device in a similar manner as the first computing device 106. The first computing device 302 can launch a web browser (312). In some examples, the first computing device 302 can launch the web browser (312) in association with a user account, such as a user account associated with the user 102. In some examples, the first computing device 302 can log into the user account after launching the web browser (312). In some examples, the first computing device 302 can log into the user account before launching the web browser (312).

In some examples, the user account is maintained by an account server 306. The account server 306 can be a server that communicates with client devices (such as first computing device 302 and second computing device 304) via the Internet. The account server 306 can maintain email accounts, web browsing accounts, and/or file storage accounts, as non-limiting examples. In some examples, the user logs into the user account by logging into the account server 306 with a username and password (or passcode, passkey, facial identifier, fingerprint, or other authentication mechanism) associated with the user account.

The first computing device 302 can send a content request 314 to a content server 308. The first computing device 302 can send the content request 314 in association with a content locator. The content request 314 can, for example, include the content locator. The content locator can, for example, identify and/or address the content server 308. The content locator can include, for example, a URL. In some examples, the content request 314 includes a HyperText Transfer Protocol (HTTP) GET request. The content request 314 can request the content server 308 to generate and return content identified by the content request 314, such as content identified by a Uniform Resource Identifier (URI). In some examples, the requested content can be identified by a portion of a URL included in an address bar of the web browser, such as a path file included in the URL. In some examples, the content server 308 is identified and/or addressed by a portion of the URL included in the address bar of the web browser, such as a domain name included in the URL.

The content server 308 can be a web server that hosts content. The content server 308 can be configured to respond to content requests, such as HTTP requests, by sending content to the requesting computing device. The content server 308 can be associated with a URL and/or domain name. The content server 308 can respond to the content request by sending content 316 to the first computing device 302. In some examples, the content server 308 sends the content 316 to the first computing device 302 within an HTTP response. The content 316 can include, for example, a HyperText Markup Language (HTML) file.

The first computing device 302 can present the content (318) received from the content server 308. The first computing device 302 can present the content (318) by, for example, rendering and presenting the content 316 within the browser executing on the first computing device 302. In some examples, the first computing device 302 presents the content (318) in association with a tab on the web browser. In some examples, the first computing device 302 presents the content (318) in association with a content locator. The content locator stored by the first computing device 302 can be the same content locator that was associated with the content request 314.

The user of the first computing device 302 may request to view different content, such as by typing a different address into an address bar of the web browser executing on the first computing device 302 or by selecting a hyperlink presented by the web browser.

The first computing device 302 can respond to the request to view different content by sending a content request 320 to another content server 310. The content request 320 can have similar features to the content request 314, with a different content locator and/or identifier of content. The content server 310 can have similar features to the content server 308, with a different address and/or identifier and different content. The content server 310 can respond to the content request 320 by sending content 322 to the first computing device 302. The content 322 can have similar features to the content 316, with different content included in the content 322 than the content 316. The first computing device 302 can respond to receiving the content 322 by presenting content (324). The first computing device 302 can present the content (324) in a similar manner to presenting the content (318), with the presentation of the content (324) being based on the content 322 received from the content server 310. The first computing device 302 can send content locators 326 to an account server 306. The first computing device 302 can send content locators 326 to the account server 306 in association with a user account, such as a user account that is logged into the account server 306 via the first computing device 302. The user account can be associated with and/or accessible by the user of the first computing device 302. The user may have logged onto the user account while interacting with the first computing device 302. The account server 306 can be a server that maintains accounts on behalf of users. The accounts can, for example, be email accounts, web browsing accounts, and/or file storage accounts. While FIG. 3 shows the first computing device 302 sending the content locators 326 to the account server 306 after the presentation of content (318, 324), the first computing device 302 can send the content locators 326 to the account server 306 at any time, either together or individually. In some examples, the first computing device 302 sends the content locators 326 to the account server 306 in association with, and/or in response to, sending the content requests 314, 320. The account server 306 stores the content locators 326 in association with the user account.

The user may begin using and/or interacting with a second computing device 304 after using and/or interacting with the first computing device 302. In some examples, the user begins using and/or interacting with a second computing device 304 after using and/or interacting with the first computing device 302 in a similar manner to that described above with respect to FIGS. 1A, 1B, and 1C. In some examples, the second computing device 304 is considered a current computing device and the first computing device 302 is considered a previous computing device. The user can log into the user account. The user can log into the user account with the account server 306 via the second computing device 304. While FIG. 3 shows two computing devices 302, 304 associated with the user account, locators can be shared and/or synchronized between any number of computing devices via which the user logs into the user account.

The second computing device 304 can launch a web browser (328). The second computing device 304 can launch the web browser (328) in response to the user selecting the web browser and/or in response to the user requesting the second computing device 304 to launch the web browser. In some examples, the second computing device 304 launches the web browser (328) in association with the user account. In some examples, the user and/or second computing device 304 logs into the user account via the web browser.

The second computing device 304 sends a locator request 330 to the account server 306. The second computing device 304 sends the locator request 330 in association with the user account. The locator request 330 requests, from the account server 306, the content locators associated with content that the user accessed via the first computing device 302 and/or previous computing device.

The account server 306 responds to the locator request 330 by sending, to the second computing device 304, locators 332 stored by the account server 306 in association with the user account. The locators 332 identify content locators associated with content accessed by the user in association with the user account via the first computing device 302 and/or previous computing device. The second computing device 304 stores the locators 332 in a memory included in the second computing device 304, such as in a locator store 617 (shown in FIG. 6A) that is included in the memory.

In response to receiving the locators 332, the second computing device 304 and/or web browser executing on the second computing device 304 filters the locators (334). Filtering the locators (334) includes filtering the content locators 332 received from the account server 306. Filtering the locators (334) includes determining which locator(s) is associated with content that is eligible for viewing on the second computing device 304. In some examples, the web browser and/or second computing device 304 can determine whether content is eligible for viewing on the second computing device 304 based on a network (such as the first network 150 or the second network 160) via which the second computing device 304 received the content locator associated with the content. In some examples, the web browser and/or second computing device 304 can determine whether content is eligible for viewing on the second computing device 304 based on interactions with the content by the user via the first computing device 302, such as the user scrolling through and/or viewing all of the content. In some examples, the web browser and/or second computing device 304 can determine whether content is eligible for viewing on the second computing device 304 based on text included in the content. In some examples, the web browser and/or second computing device 304 can determine whether content is eligible for viewing on the second computing device 304 based on a classification of the content locator associated with the content.

In some examples, the web browser and/or second computing device 304 determines that content associated with one or more of the content locators 332 is eligible for viewing on the second computing device 304 and/or current computing device and that content associated with one or more other of the content locators 332 is not eligible for viewing on the second computing device 304 and/or current computing device. In the example shown in FIG. 3, the web browser and/or second computing device 304 determines that content associated with a first content locator that is associated with the content server 308 is eligible for viewing on the second computing device 304. Based on determining that content associated with the first content locator is eligible for viewing on the second computing device 304, the second computing device 304 presents the first content locator (336). In the example shown in FIG. 3, the web browser and/or second computing device 304 determines that content associated with a second content locator that is associated with the content server 310 is not eligible (and/or is ineligible) for viewing on the second computing device 304. The terms “ineligible” and “not eligible” are used interchangeably herein. Based on determining that content associated with a second content locator that is associated with the content server 310 is not eligible (and/or is ineligible), the second computing device 304 deletes the second content locator (338) from the memory included in the second computing device 304, such as the locator store.

Based on determining that the content associated with the first content locator that is associated with the content server 308 is eligible for viewing on the second computing device 304, the second computing device 304 sends a content request 340 to the content server 308, and the content server 308 responds to receiving the content request 340 by sending content 342 to the second computing device 304. The content request 340 has similar features to the content request 314, and the content 342 has similar features to the content 316. Based on determining that the content associated with the second content locator that is associated with the content server 310 is not eligible (and/or is ineligible) for viewing on the second computing device 304, the second computing device 304 does not sends a content request to the content server 310. In some examples, the second computing device 304 does not send a content request to the content server 310 and/or present content associated with the second content locator and/or content server 310 during a current browsing session. In response to receiving the content 342, the second computing device 304 presents content (344) within the web browser executing on the second computing device 304. The presentation of content (344) has similar features as the presentation of content (318). The second computing device 304 can present the content (344) associated with the first content locator and/or content server 308 within the web browser executing on the second computing device 304 without presenting content associated with the second content locator and/or content server 310.

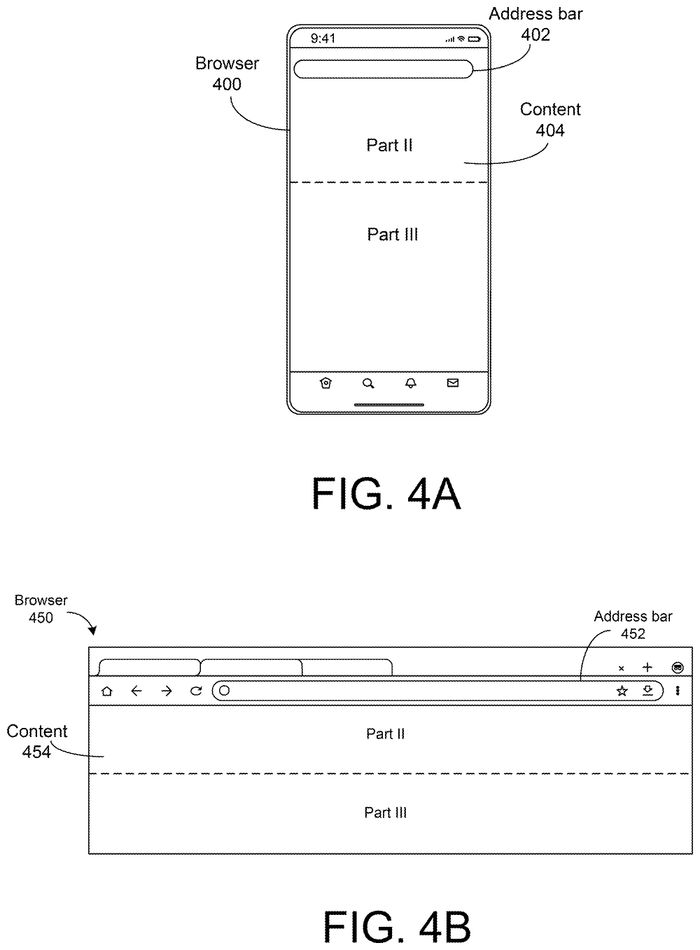

In some examples, a current computing device and previous computing device can maintain continuity of content for the user when the user switches from the previous computing device to the current computing device. The current computing device can maintain continuity of content with the previous computing device by presenting a same portion of content as the previous computing device was presenting when the user stopped using the previous computing device and/or stopped accessing or viewing the content on the previous computing device. FIGS. 4A and 4B show browsers presenting content and maintaining continuity of content.

FIG. 4A shows a web browser 400 presenting content 404 in which a portion of the content 404 has already been viewed. The web browser 400 includes an address bar 402 that presents a content locator associated with the content 404. In the example of FIG. 4A, the web browser 400 is executing on a mobile computing device such as a smartphone. The computing device on which the web browser 400 is executing can be considered a previous computing device. The computing device on which the web browser 400 is executing can have similar features to the first computing device 106 described above with respect to FIG. 1A. In the example shown in FIG. 4A, the user has already viewed a Part I of the content 404, which could be a news article, and is viewing an end portion of a Part II and a beginning portion of a Part III of the content 404. The previous computing device and/or web browser 400 may have sent the account server 306 (not shown in FIG. 4A) an indication of a location within the content 404 where the user was viewing when the user stopped viewing and/or accessing the content 404. The user may thereafter stop viewing and/or accessing the content 404 on the previous computing device, and begin accessing content on a current computing device.

FIG. 4B shows another web browser 450 presenting the content 454 presented by the web browser 400 of FIG. 4A. In this example, the web browser 450 is executing on a current computing device that can be a desktop computing device with a wide display. The computing device on which the web browser 450 is executing can have similar features to the second computing device 126 described above with respect to FIG. 1B. The web browser 450 includes an address bar 452 that presents a content locator associated with the content 454.

The current computing device on which the web browser 450 is executing may have received, from the account server 306 (not shown in FIG. 4A), in addition to the content locator associated with the content 404 that the user was accessing on the previous computing device and the content 454 that the user accesses on the current computing device, an indication of the portion of the content 404 that the user was viewing when the user stopped viewing and/or accessing the content on the previous computing device. Based on the indication, the web browser 450 can scroll to and/or present a same portion of the content 454 as the portion of the content 404 that the user was last viewing on the previous computing device, maintaining continuity of viewing of the content 404, 454.

Besides the effect of maintaining continuity, the current computing device provides, in this manner, a same portion of the content 454 as the portion of the content 404 that the user was last viewing on the previous computing device more quickly than if the user were to manually provide the content locator to the current computing device and scroll to the portion of the content 454 as the portion of the content 404 that the user was last viewing on the previous computing device.

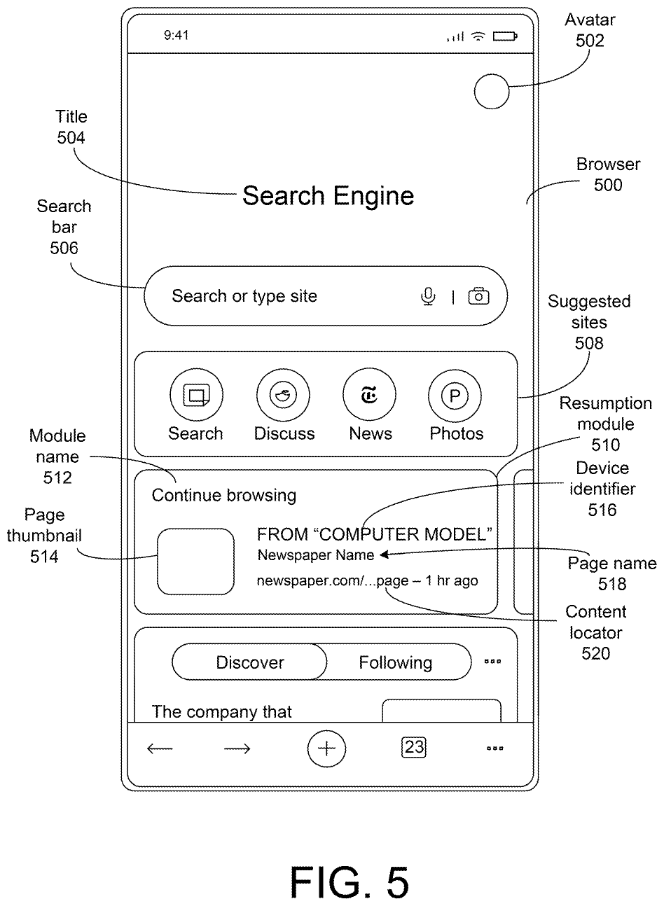

FIG. 5 shows a web browser 500 with user interface elements that facilitate viewing desired content. The web browser 500 can be an example of, and/or include any combination of features of, any of the web browsers described above. The web browser 500 can execute on a current computing device.

The web browser 500 can include an avatar 502. The avatar 502 can indicate whether a user is logged into the web browser 500 in association with a user account. If the user is logged into the web browser 500 in association with a user account, then the avatar 502 will include and/or present an avatar or icon associated with the user account. If the user is not logged into the web browser 500 in association with a user account, then the avatar 502 will include and/or present a generic icon that is not associated with any user account.

The web browser 500 can include a title 504. The title 504 can be a title of a homepage that the web browser 500 opens by default and/or without instruction to open a particular page. In some examples, the title 504 is a name of a search engine.

The web browser 500 can include a search bar 506. The search bar 506 includes an input field that receives a search query. The search query can include textual input. The web browser 500 can send the search query to a server that implements a search engine, and receive and present search results in response to the search query.

The web browser 500 can include a suggested sites section 508. The suggested sites section 508 can include indicators of suggested websites and/or suggested content. The indicators of suggested websites and/or suggested content can include icons associated with the suggested websites and/or suggested content. In some examples, the indicators of suggested websites and/or suggested content can be presented as a list. In some examples, the indicators of suggested websites and/or suggested content can include multiple content locators. The suggested sites section 508 can be considered a graphical element. The web browser 500, and/or a server in communication with the web browser 500 (such as the account server 306), can determine the suggested websites and/or suggested content based on web browsing patterns associated with the user account. In some examples, the suggested websites, suggested content, and/or content locators were previously accessed by computing devices, such as the previous computing device and/or an additional computing device, in association with the user account. In some examples, the web browser 500 and/or a server in communication with the web browser 500 determines and/or selects the suggested websites and/or suggested content based on websites and/or content locators that the user account has most frequently visited within a predetermined time period or a predetermined number of visits to websites.

The web browser 500 can include a resumption module 510. The resumption module 510 can facilitate resumption of a web browsing session between devices associated with the user account, and/or between sessions of executing the web browser 500 on the same computing device. The resumption module 510 can present a portion of, and/or present an option to view, content accessed on a previous computing device in association with the user account. In some examples, the resumption module 510 can present a portion of, and/or present an option to view, a most recent tab and/or content most recently accessed on a previous computing device in association with the user account within a predetermined time period, such as the last twenty-four hours. The resumption module 510 can present the portion of and/or option to view content accessed on the previous computing device in association with the user account that the current computing device on which the web browser 500 is executing has determined is eligible for viewing on the current computing device.

The resumption module 510 can include a module name 512. The module name 512 can indicate a name and/or function of the resumption module 510. In the example shown in FIG. 5, the module name 512 is, “Continue Browsing,” indicating that the resumption module 510 enables the user to continue a browsing session.

The resumption module 510 can include a page thumbnail 514. The page thumbnail 514 can display and/or present a thumbnail image of, and/or a reduced portion of, content accessed on a previous computing device in association with the user account. In some implementations, the page thumbnail 514 may be an image selected from the content. The page thumbnail 514 can display and/or present a preview of content that the user can access and/or view by selecting the resumption module 510. The page thumbnail 514 can display and/or present a preview of a most-recent tab and/or content most recently accessed on a previous computing device in association with the user account.

The resumption module 510 can include a device identifier 516. The device identifier 516 can identify the previous device via which the user and/or user account accessed the content indicated by the page thumbnail 514. In some examples, the device identifier 516 identifies the previous device by a manufacturer name and model name of the previous device. In some examples, the device identifier 516 identifies the previous device by a device name assigned to the previous device by the user and/or in association with the user account.

The resumption module 510 can include a page name 518. The page name 518 can include and/or present a name or title of a webpage associated with the content indicated by the page thumbnail 514 and/or the content that the user can access and/or view by selecting the resumption module 510.

The resumption module 510 can include a content locator 520. The content locator 520 can include a content locator associated with the webpage that is associated with the content indicated by the page thumbnail 514 and/or the content that the user can access and/or view by selecting the resumption module 510. The content locator 520 can include, for example, a URL associated with the webpage and/or content. In some examples, the full content locator and/or URL may not fit within the space assigned for the content locator 520 within the resumption module 510, and the content locator 520 may include and/or present a truncated version of, or portion of, the content locator and/or URL.

In some examples, the web browser 500 can respond to a selection of the resumption module 510, such as a tap or click on the resumption module 510, by presenting the content associated with the content locator presented content locator 520. Examples of presenting the content within the web browser 500 are shown in FIGS. 1A (display 108), 1B (display 128), 2A (web browser 200), 2B (web browser 220), 2C (web browser 240), 4A (web browser 400), and 4B (web browser 450). In some examples, the web browser 500 presents the page thumbnail 514, page name 518, and/or content locator 520 associated with content based on determining that the content is eligible for viewing on the current device. In some examples, the web browser 500 presents the page thumbnail 514, page name 518, and/or content locator 520 associated with content based on determining that the content is the most likely content that the user will view on the current device. In some examples, the web browser 500 presents the page thumbnail 514, page name 518, and/or content locator 520 associated with content based on determining that the content is the most recently viewed content on the previous device.

In some examples, the web browser 500 can hide the resumption module 510 in response to user input. The web browser 500 can hide the resumption module 510 in response to the user long-pressing (tapping and holding) the resumption module 510. Hiding the resumption module 510 can include ceasing to present the resumption module 510 and/or ceasing to receive input via the resumption module 510.

In some examples, the web browser 500 will continue presenting the resumption module 510 after a user selects the page thumbnail 514, page name 518, and/or content locator 520. In some examples, selection of the page thumbnail 514, page name 518, and/or content locator 520 will cause the web browser 500 to stop presenting the page thumbnail 514, page name 518, and/or content locator 520, and/or cause the web browser 500 to stop presenting the resumption module 510.

FIG. 6A is a block diagram of a computing device 600. The computing device 600 can represent the first computing device 106, the second computing device 126, the first computing device 302, the second computing device 304, the account server 306, the content server 308, and/or the content server 310. The methods, functions, and/or techniques described with respect to the 600 can be performed by a single computing device and/or server, or distributed between multiple computing devices and/or servers.

The computing device 600 can include a browser launcher 602. The browser launcher 602 can launch a web browser on the computing device 600. In some examples, the browser launcher 602 launches the web browser on the computing device 600 in association with a user account. In some examples, the browser launcher 602 launches the web browser in response to user request, such as the user clicking on or otherwise selecting an icon associated with the web browser.

The computing device 600 can include a locator receiver 604. The locator receiver 604 can receive content locators from another computing device, such as the account server 306. The locator receiver 604 can receive content locators associated with content that the user accessed on a previous computing device.

The computing device 600 can include an eligibility determiner 606. The eligibility determiner 606 determines eligibility of content locators, and/or content associated with content locators, for viewing on the current computing device (such as the computing device 600). The eligibility determiner 606 can determine the eligibility of content locators and/or content based on multiple criteria or factors.

In some examples, the eligibility determiner 606 determines whether a content locator and/or associated content is eligible for viewing on the current computing device based on text included in the content. For example, if the text includes textual content that has been determined to be inappropriate for a work environment, then the eligibility determiner 606 can determine that the content locator and/or associated content is ineligible for viewing on the computing device 600. If the text does not include any textual content that has been determined to be inappropriate for a work environment, then the eligibility determiner 606 can determine that the content locator and/or associated content is eligible for viewing on the computing device 600.

In some examples, the eligibility determiner 606 determines whether a content locator and/or associated content is eligible for viewing on the current computing device based on a classification of the content locator. The content locator can be classified based on words included in a title of a webpage associated with the content locator, or based on websites that have similar visitation patterns, as non-limiting examples. For example, if the content locator is included in a list or group that has been determined to be inappropriate for a work environment, and/or is not included in a list or group that has been determined to be appropriate for a work environment, then the eligibility determiner 606 can determine that the content locator and/or associated content is ineligible for viewing on the computing device 600. If the content locator is not included in a list or group that has been determined to be inappropriate for a work environment, and/or is included in a list or group that has been determined to be appropriate for a work environment, then the eligibility determiner 606 can determine that the content locator and/or associated content is eligible for viewing on the computing device 600.

In some examples, eligibility is determined on the basis of the size of a webpage when loaded from a server. A current device, for example a mobile phone, determines a content locator and/or associated content as ineligible, if the volume of the data to be transferred to present the content of a webpage on the current device exceeds a certain threshold value. In this manner, the use of bandwidth and the volume of data to be transferred in a bandwidth-limited environment are limited.

In some examples, eligibility is determined on the basis of the requirements of a webpage on the presentation resources. For example, consider a webpage that requires a certain minimum screen size to render properly. If a current device, for example a mobile device with limited screen size and presentation resources, does not provide the required presentation resources, a content locator and/or associated content is determined to be ineligible for the current device. In this manner, retrieval of content that cannot be rendered on the current device can be avoided, resulting in bandwidth and/or data savings.

In some examples, eligibility is determined on the basis of the network to which a current device is connected. For example, certain webpages provide confidential data that should not be transferred over unsecure (e.g. unencrypted) networks. In the event that the current device is connected to an unsecure network, a content locator and/or associated content will be classified as ineligible, if it is determined to refer/include sensitive information. Sensitive information can, for example, include authentication credentials. Furthermore, a content locator can be determined as ineligible, if authentication credentials are required to retrieve associated content and the current device does not have the authentication credentials. In this manner, network security is enhanced and unintended leakage of sensitive information can be avoided.

In some examples, the eligibility determiner 606 determines whether a content locator and/or associated content is eligible for viewing on the current computing device based on a network via which the locator receiver 604 received the content locator. In some examples, if the locator receiver 604 received the content locator via a personal network or cellular network, then the eligibility determiner 606 may determine that any content is eligible for viewing on the computing device 600 based on the assumption that the user's browsing activity is private. In some examples, if the locator receiver 604 received the content locator via a network associated with a work environment, then the eligibility determiner 606 may determine whether the content locator and/or content is eligible based on whether the content locator and/or content is considered suitable for a work environment.

In some examples, the eligibility determiner 606 determines whether a content locator and/or associated content is eligible for viewing based on interactions by the user with the content on the previous computing device. For example, if the user has scrolled through all of the content, indicating that the user has finished viewing all of the content, then the eligibility determiner 606 may determine that the content locator and/or content is not eligible for viewing on the computing device 600.

In some examples, the computing device 600 presents a predetermined number, and/or a maximum of a predetermined number, of content locators for selection by the user. The presented content locators can be the content locators that the computing device 600 has determined are most likely to be selected by the user and are eligible for viewing. The eligibility can be determined by the eligibility determiner 606. Likelihood can be determined by a likelihood determiner 608.

The computing device 600 can include a likelihood determiner 608. The likelihood determiner 608 can determine predicted likelihoods of content locators and/or associated content being selected by a user of the computing device 600. In some examples, the likelihood determiner 608 can determine likelihoods of content locators and/or associated content being selected by a user of the computing device 600 based on how recently the content was accessed by the user on the computing device 600 and/or on a previous computing device. In some examples, the likelihood determiner 608 can determine likelihoods of content locators and/or associated content being selected by a user of the computing device 600 based on how frequently the content was accessed by the user on the computing device 600 and/or on a previous computing device within a predetermined time period. In some examples, the likelihood determiner 608 can determine likelihoods of content locators and/or associated content being selected by a user of the computing device 600 based on interactions by the user with the content on the computing device 600 and/or on a previous computing device. In some examples, the likelihood determiner 608 can determine likelihoods of content locators and/or associated content being selected by a user of the computing device 600 based on a classification of the content locator. In some examples, the likelihood determiner 608 can determine likelihoods of content locators and/or associated content being selected by a user of the computing device 600 based on a ranking of one or more documents included in the content associated with the content locator. In some examples, the likelihood determiner 608 can determine likelihoods of content locators and/or associated content being selected by a user of the computing device 600 based on the depth of navigation (such as number of hyperlinks to be selected) to arrive at the content locator (a content locator with a greater depth of navigation may be more likely to be presented to save the user more navigation). In some examples, the likelihood determiner 608 can determine likelihoods of content locators and/or associated content being selected by a user of the computing device 600 based on how often the user has accessed the content associated with the content locator. In some examples, the likelihood determiner 608 can determine likelihoods of content locators and/or associated content being selected by a user of the computing device 600 based on whether the associated content has been read, viewed, and/or accessed by the user. In some examples, the likelihood determiner 608 can determine likelihoods of content locators and/or associated content being selected by a user of the computing device 600 based a current time of day.

The computing device 600 can include a locator presenter 610. The locator presenter 610 can present content identified by content locators within a web browser. In some examples, the locator presenter 610 presents the content within tabs of the web browser. The presented content locators are available for selection, such as via the tabs, by the user. In some examples, the locator presenter 610 presents the content locators in an order of likelihood of selection determined by the likelihood determiner 608.

The computing device 600 can include a content presenter 612. The content presenter 612 can present content within the web browser. The content presenter 612 can present content associated with a content locator selected by the user. The content presented by the content presenter 612 can be content received from a server, such as either of the servers 308, 310. Examples of content presented by the content presenter 612 include the content 112 of FIG. 1A, content 132 of FIG. 1B, content 206 of FIG. 2A, content 226 of FIG. 2B, content 246 of FIG. 2C, content 404 of FIG. 4A, and/or content 454 of FIG. 4B.

The computing device 600 can include at least one processor 614. The at least one processor 614 can execute instructions, such as instructions stored in at least one memory device 616, to cause the computing device 600 to perform any combination of methods, functions, and/or techniques described herein.

The computing device 600 can include at least one memory device 616. The at least one memory device 616 can include a non-transitory computer-readable storage medium. The at least one memory device 616 can store data and/or instructions thereon that, when executed by at least one processor, such as the processor 614, are configured to cause the computing device 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing device 600 can be configured to perform, alone, or in combination with other computing devices, any combination of methods, functions, and/or techniques described herein.

The at least one memory device 616 can include a locator store 617. The locator store 617 can store content locators, such as content locators presented by the locator presenter. The content locators stored by the locator store 617 can include the content locators 332 received by the second computing device 304 (or third or n^{th} computing device) from the account server 306 in the example described with respect to FIG. 3.

The computing device 600 may include at least one input/output node 618. The at least one input/output node 618 may receive and/or send data, such as from and/or to, the account server 306, and/or may receive input and provide output from and to a user. The input and output functions may be combined into a single node, or may be divided into separate input and output nodes. The input/output node 618 can include, for example, a microphone, a camera, a display, a speaker, a microphone, one or more buttons, and/or one or more wired or wireless interfaces for communicating with other computing devices and/or servers.

FIG. 6B is a diagram of a server 650. The server 650 can be an example of the server 170 shown in FIG. 1C and/or the server 306 shown in FIG. 3. In some examples, the computing device 600 may communicate with the server 650 over a network. The server 650 may be a computing device or computing devices that take the form of a number of different devices, for example a standard server, a group of such servers, or a rack server system. In some examples, the server 650 may be a single system sharing components such as processors and memories. The network over which the computing device 600 communicates with the server 650 may include the Internet and/or other types of data networks, such as a local area network (LAN), a wide area network (WAN), a cellular network, satellite network, or other types of data networks. The network may also include any number of computing devices (e.g., computer, servers, routers, network switches, etc.) that are configured to receive and/or transmit data within a network. The network may further include any number of hardwired and/or wireless connections.

The server 650 may include one or more processors 652 formed in a substrate, an operating system (not shown) and one or more memory devices 654. The memory devices 654 may represent any kind of (or multiple kinds of) memory (e.g., RAM, flash, cache, disk, tape, etc.). In some examples (not shown), the memory devices 654 may include external storage, e.g., memory physically remote from but accessible by the server 650. The server 650 may include one or more modules or engines representing specially programmed software. For example, the server 650 may include systems for managing and accessing user account(s) 660. The user accounts 660 may include data that a user has requested to be synchronized across devices, such as computing device 600. The synchronized data can include session data 662. The session data 662 can enable a user to resume browsing activity after switching devices. The user account 660 may also include profile data 664. The profile data 664 may include, with user consent, information describing the user. The profile data 664 may also include data that identifies a user (e.g., a username and password). The user account 660 may also include synchronized saved resource storage 666. The saved resource storage 666 may be a data store of saved resources for the user across devices. For example, as part of a synchronization activity a local saved resource storage may be sent from the computing device 600 to the server 650 and saved in saved resource storage 666.

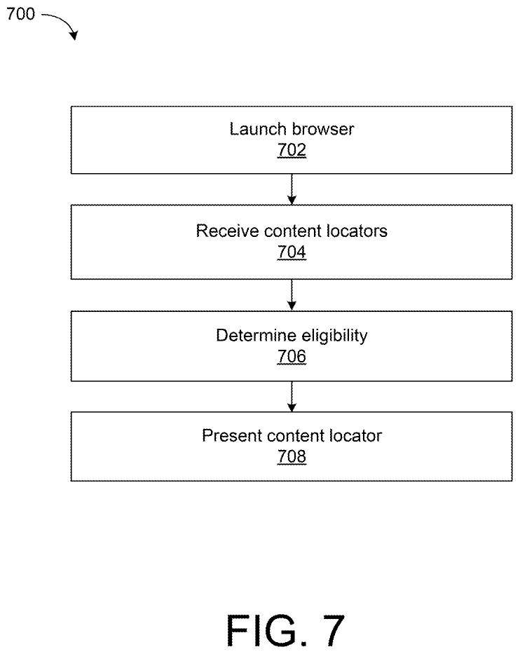

FIG. 7 is a flowchart of a method 700 performed by a computing device. The method 700 can be performed by a computing device such as the computing device 600.

The method 700 can include launching a browser (702). The launching of the browser (702) can be similar to launching the browser (328) as described above with respect to FIG. 3. The method 700 can include receiving content locators (704). Receiving content locators (704) can include receiving a first content locator and a second content locator. Content associated with the first content locator can be previously accessed by a previous computing device in association with a user account. Content associated with the second content locator can be previously accessed by the previous computing device in association with the user account. The method 700 can include determining eligibility (706). Determining eligibility (706) can include determining that the content associated with the first content locator is eligible for viewing on the current computing device. Determining eligibility (706) can include determining that the content associated with the second content locator is ineligible for viewing on the current computing device. The method 700 can include presenting a content locator (708). Presenting a content locator (708) can include presenting, using a web browser associated with the user account, content associated with the first content locator without presenting content associated with the second content locator based on the determination that the content associated with the first content locator is eligible for viewing on the current computing device and the determination that the content associated with the second content locator is ineligible for viewing on the current computing device.

In some examples, the method 700 further includes receiving a third content locator, content associated with the third content locator being previously accessed within the previous computing device in association with the user account; determining that the content associated with the third content locator is eligible for viewing on the current computing device; and presenting, within the web browser, the third content locator based on the determination that the content associated with the third content locator is eligible for viewing on the current computing device.

In some examples, the first content locator and the third content locator are listed in an order of a predicted likelihood of being selected.

In some examples, the determination that the content associated with the second content locator is ineligible for viewing on the current computing device is based on a network via which the current computing device received the first content locator and the second content locator.

In some examples, the determination that the content associated with the second content locator is ineligible for viewing on the current computing device is based on interaction with the content associated with the second content locator via the previous computing device indicating that a user has finished viewing the content associated with the second content locator.

In some examples, the determination that the content associated with the second content locator is ineligible for viewing on the current computing device is based on text included in the content associated with the second content locator.

In some examples, the determination that the content associated with the second content locator is ineligible for viewing on the current computing device is based on a classification for the second content locator.

In some examples, the instructions are further configured to cause the current computing device to present, within the web browser, the content associated with the first content locator based on the determination that the content associated with the first content locator is eligible for viewing on the current computing device.

In some examples, the presentation of the content associated with the first content locator includes navigating to a portion of the content associated with the first content locator based on interaction with the content associated with the first content locator on the previous computing device.

In some examples, the method 700 further includes deleting the second content locator based on the determination that the content associated with the second content locator is ineligible for viewing on the current computing device.

In some examples, the web browser is a multi-tabbed web browser and the presentation of the first content locator includes presenting the content associated with the first content locator in association with a tab included in the multi-tabbed web browser.

In some examples, the tab is a first tab and the method further includes receiving a third content locator, content associated with the third content locator being previously accessed within the previous computing device in association with the user account, determining that the content associated with the third content locator is eligible for viewing on the current computing device, and generating a second tab in the multi-tabbed web browser, the second tab being associated with the third content locator.

In some examples, the web browser includes a graphical element listing multiple additional content locators, the multiple additional content locators being previously accessed by computing devices associated with the user account, the computing devices including the previous computing device and at least one additional computing device.

In some examples, the additional content locators are listed in an order of a predicted likelihood of being selected.

In some examples, the launching the web browser (702) includes launching the web browser in association with the user account.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the disclosed implementations.

What is claimed is:

1. A non-transitory computer-readable storage medium comprising instructions stored thereon that, when executed by at least one processor, are configured to cause a current computing device to:
receive a first content locator and a second content locator, content associated with the first content locator being previously accessed by a previous computing device in association with a user account and content associated with the second content locator being previously accessed by the previous computing device in association with the user account;
determine that the content associated with the first content locator is eligible for viewing on the current computing device;
determine that the content associated with the second content locator is ineligible for viewing on the current computing device; and
present, using a web browser associated with the user account, content associated with the first content locator without presenting content associated with the second content locator based on the determination that the content associated with the first content locator is eligible for viewing on the current computing device and the determination that the content associated with the second content locator is ineligible for viewing on the current computing device.

2. The non-transitory computer-readable storage medium of claim 1, wherein the instructions are further configured to cause the current computing device to:
receive a third content locator, content associated with the third content locator being previously accessed within the previous computing device in association with the user account;
determine that the content associated with the third content locator is eligible for viewing on the current computing device; and
present, within the web browser, the third content locator based on the determination that the content associated with the third content locator is eligible for viewing on the current computing device.

3. The non-transitory computer-readable storage medium of claim 2, wherein the first content locator and the third content locator are listed in an order of a predicted likelihood of being selected.

4. The non-transitory computer-readable storage medium of claim 1, wherein the determination that the content associated with the second content locator is ineligible for viewing on the current computing device is based on a network via which the current computing device received the first content locator and the second content locator.

5. The non-transitory computer-readable storage medium of claim 1, wherein the determination that the content associated with the second content locator is ineligible for viewing on the current computing device is based on interaction with the content associated with the second content locator via the previous computing device indicating that a user has finished viewing the content associated with the second content locator.

6. The non-transitory computer-readable storage medium of claim 1, wherein the determination that the content associated with the second content locator is ineligible for viewing on the current computing device is based on text included in the content associated with the second content locator.

7. The non-transitory computer-readable storage medium of claim 1, wherein the determination that the content associated with the second content locator is ineligible for viewing on the current computing device is based on a classification for the second content locator.

8. The non-transitory computer-readable storage medium of claim 1, wherein the instructions are further configured to cause the current computing device to present, within the web browser, the content associated with the first content locator based on the determination that the content associated with the first content locator is eligible for viewing on the current computing device.

9. The non-transitory computer-readable storage medium of claim 8, wherein the presentation of the content associated with the first content locator includes navigating to a portion of the content associated with the first content locator based on interaction with the content associated with the first content locator on the previous computing device.

10. The non-transitory computer-readable storage medium of claim 1, wherein the instructions are further configured to cause the current computing device to delete the second content locator based on the determination that the content associated with the second content locator is ineligible for viewing on the current computing device.

11. The non-transitory computer-readable storage medium of claim 1, wherein:
the web browser is a multi-tabbed web browser; and
the presentation of the first content locator includes presenting the content associated with the first content locator in association with a tab included in the multi-tabbed web browser.

12. The non-transitory computer-readable storage medium of claim 11, wherein the tab is a first tab and the instructions are further configured to cause the current computing device to:
receive a third content locator, content associated with the third content locator being previously accessed within the previous computing device in association with the user account;
determine that the content associated with the third content locator is eligible for viewing on the current computing device; and
generate a second tab in the multi-tabbed web browser, the second tab being associated with the third content locator.

13. The non-transitory computer-readable storage medium of claim 1, wherein the web browser includes a graphical element listing multiple additional content locators, the multiple additional content locators being previously accessed by computing devices associated with the user account, the computing devices including the previous computing device and at least one additional computing device.

14. The non-transitory computer-readable storage medium of claim 13, wherein the additional content locators are listed in an order of a predicted likelihood of being selected.

15. The non-transitory computer-readable storage medium of claim 1, wherein the instructions are further configured to cause the current computing device to launch the web browser in association with the user account.

16. A computing device comprising:
at least one processor; and
a non-transitory computer-readable storage medium comprising instructions stored thereon that, when executed by the at least one processor, are configured to cause the computing device to:
receive a first content locator and a second content locator, content associated with the first content locator being previously accessed by a previous computing device in association with a user account and content associated with the second content locator being previously accessed by the previous computing device in association with the user account;
determine that the content associated with the first content locator is eligible for viewing;
determine that the content associated with the second content locator is ineligible for viewing; and
present, using a web browser associated with the user account, content associated with the first content locator without presenting content associated with the second content locator based on the determination that the content associated with the first content locator is eligible for viewing and the determination that the content associated with the second content locator is ineligible for viewing.

17. The computing device of claim 16, wherein the instructions are further configured to cause the computing device to:
receive a third content locator, content associated with the third content locator being previously accessed within the previous computing device in association with the user account;
determine that the content associated with the third content locator is eligible for viewing; and
present, within the web browser, the third content locator based on the determination that the content associated with the third content locator is eligible for viewing.

18. The computing device of claim 17, wherein the first content locator and the third content locator are listed in an order of a predicted likelihood of being selected.

19. A method performed by a computing device, the method comprising:
receiving a first content locator and a second content locator, content associated with the first content locator being previously accessed by a previous computing device in association with a user account and content associated with the second content locator being previously accessed by the previous computing device in association with the user account;
determining that the content associated with the first content locator is eligible for viewing;
determining that the content associated with the second content locator is ineligible for viewing; and
presenting, using a web browser associated with the user account, content associated with the first content locator without presenting content associated with the second content locator based on the determination that the content associated with the first content locator is eligible for viewing and the determination that the content associated with the second content locator is ineligible for viewing.

20. The method of claim 19, further comprising:
receiving a third content locator, content associated with the third content locator being previously accessed within the previous computing device in association with the user account;
determining that the content associated with the third content locator is eligible for viewing; and
presenting, within the web browser, the third content locator based on the determination that the content associated with the third content locator is eligible for viewing.
